(19) United States
(12) Patent Application Publication
(10) Pub. No.: US 2021/0142446 A1
(43) Pub. Date: May 13, 2021

(54) IMAGE PROCESSING DEVICE, IMAGE PROCESSING METHOD, AND NON-TRANSITORY COMPUTER-READABLE MEDIUM

(71) Applicant: NEC Corporation, Tokyo (JP)

(72) Inventors: Akari SATO, Tokyo (JP); Mark Yoshitaro NISHIMURA, Tokyo (JP)

(73) Assignee: NEC Corporation, Tokyo (JP)

(21) Appl. No.: 17/093,966

(22) Filed: Nov. 10, 2020

(30) Foreign Application Priority Data
Nov. 13, 2019 (JP) 2019-205449

(51) Int. Cl. G06T 5/00

(52) U.S. Cl. CPC G06T 5/001; G06T 2207/10048

(57) ABSTRACT

An image processing device includes: at least one memory storing a set of instructions; and at least one processor configured to execute the instructions to: separate an input signal related to an image signal including near-infrared light that has passed through a filter having a part that transmits near-infrared light and a part that does not transmit near-infrared light, into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component; and restore a separation signal related to a visible light signal and a near infrared signal based on the visible light component and the near infrared component.

This application is based upon and claims the benefit of priority from Japanese Patent Application No. 2019-205449, filed on Nov. 13, 2019, the disclosure of which is incorporated herein in its entirety by reference.

### TECHNICAL FIELD

The present disclosure relates to image processing or the like.

### BACKGROUND ART

An imaging device such as a digital camera or a digital video camera generally has a configuration in which an optical filter of three colors including red (R), green (G), and blue (B) are integrated in an image sensor. Light entered the imaging device is decomposed by the three-color optical filter and is converted into signals of R, G, and B colors by the image sensor.

In a case where the image sensor used for the imaging device is a silicon-based sensor, a sensitivity of the image sensor ranges from a visible light region to a Near InfraRed (NIR) region. Therefore, when near-infrared light enters the image sensor, an output by NIR light is added to outputs related to the respective colors of R, G, and B. As a result, color reproducibility is deteriorated. Therefore, near-infrared light is removed by using a near-infrared cut filter.

On the other hand, there is a demand for photographing a near-infrared light image by using a near-infrared light sensitivity as described in NPL 1.

As disclosed in PTL 1, various methods for performing visible light photographing and near-infrared light photographing by a single imaging device have been examined. In the technology in PTL 1, an NIR sensor is provided on a lower side (side far from surface) of a photosensor part of each color of R, G, and B. Therefore, a structure and a process are more complicated than those of a structure in which one kind of photosensors are arranged in a plane, leading to higher manufacturing cost.

In PTL 2, a coded IR cut filter in which parts that transmit NIR light and parts that do not transmit the NIR light are arranged in a periodic pattern is disclosed. A video imaging device in PTL 2 acquires an NIR pattern by developing an RGB+NIR mixed signal into a frequency space by a method such as the Fourier transformation and acquires an NIR image by inverse conversion. The video imaging device acquires an RGB image from a signal from which the NIR pattern is removed. In a case where an image is captured by using the coded IR cut filter, the NIR light transmits only a part on the filter. Since it is not possible to directly restore the NIR light that does not transmit the filter by frequency conversion, a method for executing interpolation processing by using a filter is adopted in PTL 2 in order to reconstruct an entire NIR image. Such interpolation processing is estimation based on information regarding peripheral pixels or the like, and the reconstructed image is blurred.

NPL 2 proposes a method for acquiring the NIR image by preparing two types of G channels in a Bayer pattern and using a method of compressed sensing. In the method of NPL 2, a change of the Bayer pattern is needed. Therefore, it is not possible to use a general camera, leading to higher manufacturing cost. Moreover, it is technically difficult to prepare the two types of G channels having two difficult types of spectral characteristics.

NPL 3 describes the compressed sensing. PTL 3 discloses a spectral sensing device that can use the compressed sensing in the NIR region. PTL 4 discloses an image sensor in which near-infrared cut filters are provided on a light receiving element array in a predetermined pattern.

PTL 5 discloses that near-infrared light having an intensity related to a pattern having a predetermined geometric shape is acquired and color signals and near infrared signals are output by using pattern information that defines the pattern. PTL 6 discloses that a visible light image and a near-infrared light image of a subject are created on the basis of a first imaging signal output from a first light receiving element array and a second imaging signal output from a second light receiving element array.

PTL 2 and PTL 5 simplify calculation processing by using the coded IR cut filter in which the NIR transmission parts are regularly arranged. Therefore, application of the calculation processing is limited to an image signal that has passed through the coded IR cut filter in which the NIR transmission parts are regularly arranged.

### CITATION LIST

### Patent Literature

PTL 1: JP 2011-243862 A
PTL 2: WO 2015/133130 A
PTL 3: US 2015/0029503 A
PTL 4: US 2009/0200469 A
PTL 5: WO 2017/047080 A
PTL 6: JP 2014-185917 A

### Non-Patent Literature

NPL 1: Kayama Shinzo, Tanaka Keisuke, Hirose Hiroshi, “Day-and-Night Imager for Security Monitoring Cameras” Panasonic Technical Journal Vol. 54, No. 4, January 2009
NPL 2: Z. Sadeghipoor, Y M. Lu and S. Susstrunk, “A NOVEL COMPRESSIVE SENSING APPROACH TO SIMULTANEOUSLY ACQUIRE COLOR AND NEAR-INFRARED IMAGES ON A SINGLE SENSOR”, IEEE International Conference on Acoustics, Speech and Signal Processing (ICASSP), 2013
NPL 3: Toshiyuki Tanaka, “Mathematics of Compressed Sensing”, IEICE Fundamentals Review Vol. 4, No. 1, 2010
NPL 4: J. A. Tropp, “Signal Recovery from Random Measurements via Orthogonal Matching Pursuit,” IEEE Trans. Inf. Theory, Vol. 53, No. 12, 2007
NPL 5: Paul W. Hollanda and Roy E. Welsch, “Robust regression using iteratively reweighted least-squares”, Communications in Statistics—Theory and Methods, Vol. 6, No. 9, 1977
NPL 6: E. J. Candes and T. Tao, “Near-optimal signal recovery from random projections: Universal encoding strategies?”, IEEE Transactions on Information Theory, Vol. 52, No. 12, 2006
NPL 7: D. L. Donoho, “Compressed sensing”, IEEE Transactions on Information Theory, Vol. 52, No. 4, 2006

### SUMMARY

An image processing device according to the present disclosure includes at least one memory storing a set of instructions; and at least one processor configured to execute the instructions to: separate an input signal related to an image signal including near-infrared light that has passed through a filter having a part that transmits near-infrared light and a part that does not transmit near-infrared light into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component and restore a separation signal related to a visible light signal and a near infrared signal based on the visible light component and the near infrared component.

An image processing method according to the present disclosure includes separating an input signal related to an image signal including near-infrared light that has passed through a filter having a part that transmits near-infrared light and a part that does not transmit near-infrared light into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component and restoring a separation signal related to a visible light signal and a near infrared signal based on the visible light component and the near infrared component.

A non-transitory computer-readable medium storing a program according to the present disclosure causes a computer to execute processing of separating an input signal related to an image signal including near-infrared light that has passed through a filter having a part that transmits near-infrared light and a part that does not transmit near-infrared light into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component are arranged and restoring a separation signal related to a visible light signal and a near infrared signal by using the visible light component and the near infrared component.

### BRIEF DESCRIPTION OF THE DRAWINGS

Exemplary features and advantages of the present disclosure will become apparent from the following detailed description when taken with the accompanying drawings in which:

FIG. 1 is an exemplary block diagram showing a configuration of an image processing device according to a first example embodiment;

FIG. 2 is an exemplary diagram showing an example of a coded IR cut filter;

FIG. 3 is an exemplary diagram showing an example of the coded IR cut filter;

FIG. 4 is an exemplary block diagram showing a configuration of an image processing device according to a second example embodiment;

FIG. 5 is an exemplary diagram showing conversion of an acquired image signal into a vector;

FIG. 6 is an exemplary diagram showing an example of an observation matrix generated in a case where an ideal coded IR cut filter is used;

FIG. 7 is an exemplary diagram showing a linear relationship obtained by using an observation matrix;

FIG. 8 is an exemplary diagram showing an example of an observation matrix generated in a case where an actual coded IR cut filter is used;

FIG. 9 is an exemplary diagram showing a linear relationship obtained by using an observation matrix;

FIG. 10 is an exemplary block diagram showing a configuration of an image processing device according to a third example embodiment;

FIG. 11 is an exemplary schematic diagram showing a configuration of an imaging device;

FIG. 12 is an exemplary schematic diagram showing a behavior of near-infrared light entered a light reception unit;

FIG. 13 is an exemplary schematic diagram showing the configuration of the imaging device;

FIG. 14 is an exemplary schematic diagram showing the configuration of the imaging device; and

FIG. 15 is an exemplary diagram showing an exemplary hardware configuration for achieving the image processing device according to each example embodiment.

### EXAMPLE EMBODIMENT

An exemplary object of the embodiment is to provide an image processing device that acquires a separation signal related to a visible light signal and a near infrared signal from an image signal including near-infrared light regardless of how NIR transmission parts formed on a coded IR cut filter are arranged.

Hereinafter, example embodiments of the present disclosure will be described with reference to the drawings.

### First Example Embodiment

FIG. 1 is an exemplary block diagram showing a configuration of an image processing device 101 according to a first example embodiment. The image processing device 101 includes a separation unit 112 and a restoration unit 113.

The image processing device 101 is a device that outputs a separation signal related to a visible light signal and a near infrared signal from an input signal related to an image signal of an image captured in a state where the image includes the visible light and near-infrared light. Note that an arrow illustrated in the subsequent block diagrams indicates an example of a flow of a signal and does not intend that the flow of the signal is limited to a specific direction.

The image here means an image captured through an optical system such as a lens and may be either one of a still image and a moving image. The visible light signal is a signal representing a visible light image. The near infrared signal is a signal representing a near infrared image. The visible light signal and the near infrared signal represent, for example, a luminance of a pixel. However, what the signals represent are not limited only to the luminance. In the following description, the visible light signal and the near infrared signal represent a luminance of each pixel in an image at a specific time of the image in a case of a still image or an image.

In the present example embodiment, a visible light region indicates a wavelength region of 0.4 to 0.7 μm. In this wavelength region, a wavelength region of 0.4 to 0.5 μm is a blue (B) wavelength region, a wavelength region of 0.5 to 0.6 μm is a green (G) wavelength region, and a wavelength region of 0.6 to 0.7 μm is a read (R) wavelength region. A near infrared region is a wavelength region of 0.7 to two μm. However, the classification of the wavelength regions here is merely an example.

The image processing device 101 is connected to an external device that supplies the image signal. The external device is, for example, an imaging device that includes an image sensor.

In the present example embodiment, the separation unit 112 receives the input signal related to the image signal representing the image including the near-infrared light that has transmitted an optical filter having a part that transmits the near-infrared light. Such an image signal is obtained by, for example, providing a coded IR cut filter as an optical filter in front of the image sensor. The coded IR cut filter is a filter that includes a part that transmits RGB and cuts NIR (NIR cut part) and a part that transmits RGB and NIR (NIR transmission part). Therefore, the image signal is a signal representing an image in a state where a near-infrared light component is superimposed on a visible light component. In other words, the image signal is an RGB+NIR mixed signal. An input signal related to the RGB+NIR mixed signal is also referred to as an observation vector y.

FIGS. 2 and 3 are diagrams illustrating an example of the coded IR cut filter. The NIR transmission parts on the coded IR cut filter may be aligned as illustrated in FIG. 2 or may be randomly arranged as illustrated in FIG. 3. Each of the NIR transmission parts may have a circular shape as illustrated in FIGS. 2 and 3 or may have other shapes. The NIR transmission parts formed on the coded IR cut filter do not need to have the same shape. The coded IR cut filter is also referred to as an encoding IR cut filter.

The separation unit 112 separates the observation vector y related to the RGB+NIR mixed signal into an RGB signal and an NIR signal. A relationship between the RGB+NIR mixed signal and the RGB signal and the NIR signal that are separated is expressed by a linear equation by expressing an effect when light passes through the coded IR cut filter by an observation matrix M. Specifically, a relationship between the observation vector y related to the input RGB+NIR mixed signal and the RGB signal and the NIR signal that have been separated is expressed by linear calculation of a vector and a matrix as follows.

y=Mx (Eqn. 1)

In the equation above, when the number of elements of the observation vector y be n, the matrix M is a matrix referred to as an observation matrix including n rows and 2n columns. The matrix M may be, for example, a matrix in which components of a diagonal matrix of n rows and n columns having a RGB transmittance in each pixel of the image as a diagonal element are arranged alongside with components of a diagonal matrix of n rows and n columns having an NIR transmittance as a diagonal element. The transmittance may be, for example, a transmissivity. Instead of arranging the components having transmittance of the RGB as the diagonal elements of the matrix M, components of a unit matrix of n rows and n columns may be arranged (case of FIG. 6 described later). The matrix M may be stored in a storage unit (not illustrated) of the image processing device 101 in advance.

An unknown vector x is a vector having a size of 2n related to the RGB signal and the NIR signal that have been separated. For example, the unknown vector x is represented as a vector in which a vector having a size n related to the separated RGB signal along with a vector having a size n related to the separated NIR signal are arranged. The size of the vector here is described as the number of elements included in the vector. However, the size of the vector is not limited to this. Each element included in the vector may represent a luminance that is a pixel value of each pixel of the image signal. However, what the element represent is not limited to this.

In Eqn. (1), the size of the observation vector y related to the RGB+NIR mixed signal is n, whereas, the size of the vector x related to the separated signals is 2n. Therefore, it is not possible to restore the RGB signal and the NIR signal that have been separated by solving this formula by a general linear method. Therefore, a solution method using compressed sensing is used.

Here the compressed sensing will be briefly described. The compressed sensing is a method for estimating the unknown vector x from the observation vector y by solving a linear problem y=Mx in a case where the unknown vector x is sparse (that is, in a case where the number of non-zero elements is small). Here, M indicates an observation matrix.

Assume that a length of the unknown vector x be Q and a length of the observation vector y be P. The length of the vector here indicates, for example, the number of elements included in the vector. In a case of P<Q, it is not possible to obtain the vector x by using a normal method for obtaining simultaneous linear equations. However, by using sparsity of the unknown vector x, there is a case where a solution to this problem is obtained even in a case of P<Q. For example, if the number of non-zero components of the unknown vector x is K, it is found that which component of the unknown vector x is a non-zero component, and P≥K is satisfied, the unknown vector x can be correctly estimated in most cases.

Even in a case where the number and the position of the non-zero components are unknown, it is possible to correctly obtain the unknown vector x in most cases by formulating to a L0 minimization problem. In the L0 minimization problem, x is obtained as a problem for minimizing an L0 norm of the unknown vector x. The L0 norm is defined by the number of non-zero elements of the vector. In order to solve the L0 minimization problem, it is possible to use an optimization method such as orthogonal matching pursuit proposed in NPL 4, iterative reweighted least square proposed in NPL 5, or the like.

An L1 minimization problem that alleviates the L0 minimization problem is proposed in NPL 6. The L1 minimization problem is a problem that minimizes an L1 norm (sum of absolute values of non-zero elements) of the unknown vector x. Since the L1 minimization problem can be solved as a linear programming problem, there is an advantage that the L1 minimization problem can be solved by using a well-known method such as the simplex method and an interior point method.

As indicated in NPL 4 to NPL 7, the compressed sensing is a method for achieving restoration of data including a defect by using sparsity of unknown data.

In the present example embodiment, since the vector x related to the RGB signal and the NIR signal (separation signal) that have been separated is not sparse, it is not possible to directly apply a solution method of compressed sensing to Eqn. (1). However, regarding a signal generally indicating a natural image, according to development to a frequency space such as development by Discrete Cosine Transform (DCT), development to a wavelet space, or the like, a coefficient s with respect to the basic matrix Φ in the space is sparse. By using sparsity of this coefficient, it is possible to apply the solution method of the compressed sensing to Eqn. (1).

Specifically, for example, the vector x (also referred to as separation signal x) related to the RGB signal and the NIR signal that have been separated is expressed as Eqn. (2) by using a two-dimensional DCT matrix φ.

x=Φs (2)

Here, the reference s indicates a vector having a size of 2n related to a signal representing the coefficient for the DCT matrix Φ in a case where the vector x is expanded by the DCT. Here, the vectors s is a sparse signal. The separation unit 112 generates the vector s and the basic matrix Φ. When Eqn. (2) is substituted into Eqn. (1), the following Eqn. (3) is obtained.

y=MΦs (3)

Eqn. (3) can be used as the problem of the compressed sensing, and vector s is calculated by minimizing the L0 norm or the L1 norm of the vectors.

The restoration unit 113 restores a vector x that is represented by the vector s and the basic matrix Φ and is related to a visible light signal and a near infrared signal. Specifically, the restoration unit 113 obtains the vector x by substituting the vector s and the basic matrix Φ obtained by the separation unit 112 into Eqn. (2). The vector x has a size of 2n and is a separation signal related to the RGB signal and the NIR signal that have been separated.

According to the first example embodiment, the input signal related to the image signal including the near-infrared light is separated on the basis of the observation matrix M, wherein the observation matrix M include the transmittance of the near-infrared light that has passed through the coded IR cut filter as a component. Therefore, it is possible to provide the image processing device that acquires the separation signal (related to the visible light signal and the near infrared signal) from the input signal (related to the image signal including the near-infrared light) regardless of how the NIR transmission part formed on the coded IR cut filter are arranged.

According to the first example embodiment, by simply providing the coded IR cut filter in a general imaging device, the image processing device 101 acquires the input signal related to the captured image and obtains the separation signal related to the visible light signal and the near infrared signal. Therefore, it is possible to reduce manufacturing cost of the imaging device.

Moreover, according to the first example embodiment, because the compressed sensing is performed by using the sparsity of the unknown signal, it is possible to restore the visible light signal and the near infrared signal from the input signal related to a mixed signal in which the near infrared component and the visible light component are superimposed.

### Second Example Embodiment

FIG. 4 is an exemplary block diagram showing a configuration of an image processing device 102 according to a second example embodiment. The image processing device 102 according to the second example embodiment includes a signal acquisition unit 111, a separation unit 112, a restoration unit 113, an output unit 114, and a transmission pattern acquisition unit 212. The separation unit 112 and the restoration unit 113 included in the image processing device 102 have similar functions as the separation unit 112 and the restoration unit 113 in the first example embodiment. Therefore, detailed description of the separation unit 112 and the restoration unit 113 will be omitted. Hereinafter, the signal acquisition unit 111, the transmission pattern acquisition unit 212, and the output unit 114 will be described.

In the second example embodiment, the signal acquisition unit 111 acquires an image signal representing an image including near-infrared light that passes through a coded IR cut filter from an external device. In the second example embodiment, the signal acquisition unit 111 further includes an input signal conversion unit 131.

The input signal conversion unit 131 converts the input image signal into a vector suitable for calculation. Specifically, the conversion is performed as follows. FIG. 5 is an exemplary diagram showing the conversion of the acquired image signal into the vector. As illustrated in FIG. 5, supposed that an RGB+NIR mixed image including 100×100 pixels be input to the external device. The RGB+NIR mixed image is an image captured by using the coded IR cut filter and is an image expressing an RGB and NIR mixed signal. The reference y1, 1 in FIG. 5 indicates, for example, a luminance in a pixel (1, 1). In order to convert this image into a vector, for example, each component of an input image is input to an element of the vector y row by row as illustrated in FIG. 5, and this operation is performed on the next row when the row is completed. This operation is performed to the final row of the image.

The transmission pattern acquisition unit 212 acquires information (transmission pattern) regarding an effect of the coded IR cut filter on an NIR signal or an RGB signal. The transmission pattern is information representing an amount of NIR light or RGB light detected in correspondence with each pixel in a case where a while plane is imaged. This amount of light is referred to as transmissivity for convenience of description. Regarding the transmissivity, a transmissivity when the coded IR cut filter is not set may be set to one. Or else, a transmissivity of a pixel having the highest luminance when the coded IR cut filter is set may be set to be one. However, the transmission pattern does not necessarily need to be related to each pixel.

The transmission pattern acquisition unit 212 further includes an observation matrix generation unit 311. The observation matrix generation unit 311 generates an observation matrix M that is used to linearly express a relationship between an input signal y related to the RGB+NIR mixed signal and a separation signal x from the obtained transmission pattern. The transmission pattern acquisition unit 212 transmits the generated observation matrix M to the separation unit 112.

FIG. 6 is an exemplary diagram showing an example of an observation matrix generated by the observation matrix generation unit 311 in a case where an ideal coded IR cut filter is used. For example, the ideal coded IR cut filter does not affect RGB components when transmitting RGB light. Information (NIR transmission pattern) regarding the effect on the NIR signal given by the coded IR cut filter is obtained, for example, as follows. A filter that cuts a visible light component and transmits near-infrared light is mounted in a camera. A white plane is imaged by the camera, and a captured image is obtained on the basis of the NIR signal. The NIR transmission pattern can be obtained from a pattern that appears in the captured image.

The observation matrix generation unit 311 generates the observation matrix M on the basis of the information (transmission pattern) regarding the effect given by the filter on the RGB signal or the NIR signal acquired by the transmission pattern acquisition unit 212 according to the second example embodiment. Specifically, the observation matrix M is generated as follows.

For example, in a case where the ideal coded IR cut filter that does not affect the RGB signal is used, the observation matrix generation unit 311 may generate the observation matrix M as the M1 in FIG. 6. From an NIR image including 100×100 pixels obtained by cutting the visible light component, the transmission pattern acquisition unit 212 obtains the NIR transmission pattern representing an NIR transmissivity of each pixel. Since all RGB signal passes through the ideal coded IR cut filter, for example, a left half of the observation matrix M1 may be a unit matrix. As illustrated in FIG. 6, in the right half of the observation matrix M1, a transmissivity at which the NIR signal passes through the coded IR cut filter may be diagonally arranged.

FIG. 7 is an exemplary diagram showing a linear relationship obtained by using the vector y obtained by the input signal conversion unit 131 and the observation matrix M1 obtained by the observation matrix generation unit 311. In FIG. 7, a vector of an upper half of the separation signal x is related to an RGB component that has passed through the coded IR cut filter, and a vector of a lower half is related to an NIR component that has transmitted the coded IR cut filter. The separation unit 112 separates the vector y into an unknown vector x having the RGB component and the NIR component on the basis of the observation matrix M1 and expands the unknown vector x into a frequency space. The restoration unit 113 restores the vector x related to an output image by using the vector s obtained by expanding the unknown vector x by the separation unit 112 and the basic matrix Φ.

In a case where an image is captured by using an actual coded IR cut filter, when the filter is attached to the camera, a situation is considered in which incident light reflects in the camera or a diffraction phenomenon occurs after the light has passed through the filter. A slight thickness of the filter may affect the incident light. In such a case, the coded IR cut filter affects not only the NIR signal but also the RGB signal.

FIG. 8 is an exemplary diagram showing an example of an observation matrix generated by the observation matrix generation unit 311 in a case where an actual coded IR cut filter is used. In a case where the filter affects the RGB signal, the transmission pattern acquisition unit 212 acquires the information regarding the effect of the filter on the RGB signal, and the observation matrix generation unit 311 reflects the information on the observation matrix M. Similarly to the case of the NIR signal, the effect on the RGB signal is obtained, for example, as follows. First, a filter that cuts the near infrared component is mounted on a camera (imaging device) so as to make it possible to acquire a captured image on the basis of the RGB signal. When a white plane or the like is imaged, a pattern appears in the captured image. From the pattern that has appeared, information (RGB transmission pattern) regarding an effect given by the coded IR cut filter on the RGB signal may be acquired.

In a case where an image is captured by using the actual coded IR cut filter, the coded IR cut filter affects the RGB signal. Therefore, the transmission pattern acquisition unit 212 obtains the RGB transmission pattern that represents an RGB transmissivity in each pixel from an RGB image including 100×100 pixels obtained by mounting the filter that cuts the near-infrared light component on the camera (imaging device). As illustrated in FIG. 8, a transmissivity of light at which the RGB light passes through the coded IR cut filter may be diagonally arranged in the left half of the observation matrix M2. In the right half, similarly to the observation matrix M1, a transmissivity at which the NIR signal passes through the coded IR cut filter may be diagonally arranged.

FIG. 9 is an exemplary diagram showing a linear relationship obtained by using the vector y obtained by the input signal conversion unit 131 and an observation matrix M2 obtained by the observation matrix generation unit 311.

In the second example embodiment, the output unit 114 further includes an output signal conversion unit 132. By performing a procedure opposite to the procedure by the input signal conversion unit 131 illustrated in FIG. 5, the output signal conversion unit 132 converts the vector x restored by the restoration unit 113 into image information. The output unit 114 outputs two kinds of image data including an RGB image and an NIR image as the converted image information.

According to the second example embodiment, the transmission pattern acquisition unit 212 can acquire the transmission pattern, and the observation matrix generation unit 311 can generate the observation matrix on the basis of the acquired transmission pattern. Therefore, it is possible to generate the observation matrix even in a case where the transmission pattern changes. A case where the transmission pattern changes includes, for example, a case where different coded IR cut filters are provided to the same image sensor or a case where the same coded IR cut filters are provided but with different intervals between the filters and the image sensor. Moreover, the separation unit 112 can separate the RGB+NIR mixed signal on the basis of the generated observation matrix. In addition, the output unit 114 can obtain the RGB image and the NIR image.

Note that, in the second example embodiment, as an example, a case where the numbers of the pixels of the RGB+NIR mixed image, the image used to acquire the transmission pattern, and the output image are the same has been described. However, the numbers of pixels may be different.

### Third Example Embodiment

FIG. 10 is an exemplary block diagram showing a configuration of an image processing device 103 according to a third example embodiment. The image processing device 103 according to the third example embodiment is different from the image processing device 102 according to the second example embodiment in that a basic matrix update unit 411 is included.

Functions of a signal acquisition unit 111, an input signal conversion unit 131, a separation unit 112, a restoration unit 113, an output signal conversion unit 132, an image output unit 114, and a transmission pattern acquisition unit 212 included in the image processing device 103 are similar to the functions of the units in the third example embodiment. Hereinafter, an operation of the basic matrix update unit 411 will be described.

In the first to third example embodiments, the two-dimensional DCT matrix or the like has been used for the basic matrix Φ. However, according to the image, a case is expected where sparsity of a coefficient of the basic matrix is not sufficiently guaranteed and this disrupts the obtainment of a desired separation signal x. In such a case, by improving the basic matrix Φ so that a coefficient (vector s in present example embodiment) with respect to the basic matrix is more sparse than a case where the DCT matrix is used, it is possible to make a devise to obtain a restoration signal x1 closer to a correct separation signal x.

To achieve this, the basic matrix update unit 411 uses, for example, Principal Component Analysis (PCA) and utilizes the result as the basic matrix.

Specifically, for example, the following method can be used. As a learning set, a set of N RGB signals and N NIR signals is prepared (N be a natural number). On the other hand, a sparse signal s is calculated by using any one of the image processing devices 101 to 103 according to the first to third example embodiments. By performing the principal component analysis on the N sparse signals s obtained in this way, a principal component vector including a first principal component vector is obtained.

s̅=s₁+s₂+ . . . +s_{N} (4)

x1=D_{DCT}s=D_{DCT}(s′+s̅)=D_{DCT}s′+D_{DCT}s̅=D_{DCT}D_{PCA}u+D_{DCT}s̅. (5)

When a matrix DPCA having each column vector as a column is generated and a DCT matrix is expressed as DDCT, a new basic vector Φ is obtained by setting Φ=DDCTDPCA. Since redundancy of the basic vector is eliminated by the principal component analysis, a more improved sparse signal s is obtained by the separation unit 112 than a case where the DCT matrix is used. Therefore, an effect is obtained that the restoration unit 113 can obtain the restoration signal x1 that is closer to the correct separation signal x.

The configuration of the image processing device 103 illustrated in FIG. 10 is obtained by adding the basic matrix update unit 411 to the configuration of the image processing device 102 illustrated in FIG. 4. As illustrated in FIG. 10, the signal acquisition unit 111, the input signal conversion unit 131, the output signal conversion unit 132, and the output unit 114 may be separately provided from the transmission pattern acquisition unit 212 and the observation matrix generation unit 311. Similarly, a configuration in which the basic matrix update unit 411 is added to the image processing device 101 can be used.

### Fourth Example Embodiment

FIG. 11 is a schematic configuration diagram of an imaging device 300 according to a fourth example embodiment. The imaging device 300 illustrated in FIG. 11 includes a light reception unit 310 and the image processing device 102 according to the second example embodiment. Here, the image processing device 103 according to the third example embodiment may be used instead of the image processing device 102. More specifically, the light reception unit 310 includes a coded IR cut filter 211, a color filter 312, and a photosensor 313. Light containing visible light and near-infrared light enters the imaging device 300 via an optical system such as a lens.

In FIG. 11, the coded IR cut filter 211 is provided on the front side of the color filter 312 and the photosensor 313 in a traveling direction of the incident light. The coded IR cut filter 211 may be detachably or movably formed.

FIG. 12 is an exemplary schematic diagram showing a behavior of the near-infrared light entered the light reception unit 310. As illustrated in FIG. 12, the near-infrared light transmits a part of the coded IR cut filter 211 (infrared transmission part) and is cut at the other part. A method for cutting the near-infrared light is not particularly limited, and an infrared cut part may, for example, reflect or absorb near-infrared light.

The color filter 312 is a three-color optical filter having a general configuration. The color filter 312 may have so-called Bayer type arrangement. The photosensor 313 may have a configuration similar to a general image input device or imaging device. Each filter of color filter 312 is provided in correspondence with each sensor (i.e. each pixel) of the photosensor 313.

The imaging device 300 can output RGB image data expressed by colors of R, G, and B (three components) on the basis of image data expressed by the colors of R, G, and B. The imaging device 300 can output NIR image data.

[Modifications]

The example embodiment of the present disclosure is not limited to the first to fourth example embodiments described above. For example, the present disclosure can be implemented by aspects of modifications described below. The present disclosure may be implemented by an aspect obtained by appropriately combining the first to fourth example embodiments and the modifications.

(1) First Modification

In each example embodiment, the visible light component is not limited to three components of R, G, and B. For the visible light component, for example, three components of cyan (C), magenta (M), and yellow (Y) may be used. The visible light component does not need to include the three components, and the number of components may be more or less than three. In each example embodiment, the RGB color space is used for the visible light. However, a color space other than the RGB color space such as a YUV color space may be used.

(2) Second Modification

FIGS. 13 and 14 are diagrams illustrating another example of the imaging device. FIG. 13 is an exemplary diagram showing an imaging device 400 having a so-called three-panel configuration, that is, a configuration in which sensors related to R, G, and B are independent. FIG. 14 is an exemplary diagram showing an imaging device 500 including a so-called laminated sensor. The present disclosure can be applied to the imaging device having such a configuration.

The imaging device 400 includes a prism 410, photosensors 420, 430, and 440, a coded IR cut filter 450, and an image processing device 460. The prism 410 decomposes incident light and emits the light in directions according to components of R, G, and B. Each of the photosensors 420 (R), 430 (G), and 440 (B) generates a signal according to an intensity of the incident light of each color.

The coded IR cut filter 450 is an optical filter similar to the coded IR cut filter 211 according to the fourth example embodiment. It is not necessary to provide the coded IR cut filters 450 for all the photosensors 420, 430, and 440, and it is sufficient that the coded IR cut filter 450 be provided for any one of the photosensors (photosensor 420 in FIG. 13) according to spectral characteristics of the prism 410. In a case of the example in FIG. 13, it is assumed that near-infrared light that enters the photosensors 430 and 440 be sufficiently smaller than near-infrared light that enters the photosensor 420. For example, an optical filter (however, unlike coded IR cut filter 450, part that transmits near-infrared light is not formed) that cuts near-infrared light may be provided in front of the photosensors 430 and 440.

The image processing device 460 may have a configuration similar to the image processing device 102 described in the second example embodiment. However, in the example illustrated in FIG. 13, a color signal including the near-infrared light component only includes an R component. Therefore, it is only required for the image processing device 460 to execute processing for separating a near infrared signal from a color signal on a color signal only including the R component.

The imaging device 500 includes a coded IR cut filter 510, a laminated sensor 520, and an image processing unit 530. The coded IR cut filter 510 and the image processing unit 530 may respectively have configurations similar to the coded IR cut filter 450 and the image processing device 460 illustrated in FIG. 13.

The laminated sensor 520 is a sensor in which sensors 521, 522, and 523 are laminated. The sensor 521 has a sensitivity in a wavelength region of the B component. The sensor 522 has a sensitivity in a wavelength region of the G component. The sensor 523 has a sensitivity in a wavelength region of the R component and the near-infrared light component.

All or a part of the configuration of the present disclosure can be implemented by a computer. FIG. 15 is an exemplary diagram showing an exemplary hardware configuration for achieving the image processing device according to each example embodiment. For example, the image processing devices 101, 102, and 103 can be implemented by a processing device (processor) such as a Central Processing Unit (CPU) 20 and a memory such as a Random Access Memory (RAM) 21, a Read Only Memory (ROM) 22, or the like. The CPU 20 controls an operation of the image processing device by reading and executing various software programs stored in the ROM 22 on the RAM 21. That is, in each example embodiment, the CPU 20 executes the software program that executes each function (unit) included in the image processing device by appropriately referring to the ROM 22.

The present disclosure may be implemented by a general-purpose processor or may be implemented by a processor dedicated for image processing. The present disclosure may be provided in a form of a program that can be executed by a computer. This program may be provided in a form that is downloaded from other device (server or the like) via a network or may be provided in a form of a computer-readable recording medium. Moreover, the present disclosure may be provided as an image processing method in addition to the image processing device, the imaging device, the program, and the recording medium.

Although a part or all of the example embodiments may be described as supplementary notes below, a part or all of the example embodiments are not limited to the following supplementary notes.

(Supplementary Note 1)

An image processing device including:

a separation means that separates an input signal related to an image signal including near-infrared light that has passed through a filter having a part that transmits near-infrared light and a part that does not transmit near-infrared light into a visible light component and a near infrared component based on an observation matrix in which a diagonal matrix having a visible light transmission pattern indicating a transmittance of visible light by the filter as a diagonal component and a diagonal matrix having a near-infrared light transmission pattern indicating a transmittance of near-infrared light by the filter as a diagonal component are arranged; and

a restoration means that restores a separation signal related to a visible light signal and a near infrared signal by using the visible light component and the near infrared component.

(Supplementary Note 2)

The image processing device according to supplementary note 1, further including:

an acquisition means that acquires the image signal; and

an input signal conversion means that converts the image signal into the input signal that is an observation vector.

(Supplementary Note 3)

The image processing device according to supplementary note 1 or 2, further including:

a transmission pattern acquisition means that acquires a transmission pattern including the visible light transmission pattern or the near-infrared light transmission pattern; and

an observation matrix generation means that generates the observation matrix based on the acquired transmission pattern.

(Supplementary Note 4)

The image processing device according to any one of supplementary notes 1 to 3, in which

the separation means converts the visible light component and the near infrared component into a frequency region by using a basic matrix and a coefficient, and

the restoration means restores the separation signal based on the basic matrix and the coefficient.

(Supplementary Note 5)

The image processing device according to supplementary note 4, further including:

a basic matrix update unit that generates an updated basic matrix using the coefficient as an improved sparse signal and update the basic matrix, in which

the separation means converts the visible light component and the near infrared component into the frequency region based on the updated basic matrix.

(Supplementary Note 6)

The image processing device according to any one of supplementary notes 1 to 5, further including:

an output signal conversion means that converts the restored separation signal into a visible light image and a near-infrared light image.

(Supplementary Note 7)

The image processing device according to supplementary note 6, further including:

an output means that outputs the converted visible light image and near-infrared light image.

(Supplementary Note 8)

The image processing device according to any one of supplementary notes 1 to 7, in which

a length of a vector of the input signal is n (n is natural number equal to or more than 100), the observation matrix includes n rows and 2n columns, and a length of a vector of the separation signal is 2n.

(Supplementary Note 9)

An image processing method including:

separating an input signal related to an image signal including near-infrared light that has passed through a filter having a part that transmits near-infrared light and a part that does not transmit near-infrared light into a visible light component and a near infrared component based on an observation matrix in which a diagonal matrix having a visible light transmission pattern indicating a transmittance of visible light by the filter as a diagonal component and a diagonal matrix having a near-infrared light transmission pattern indicating a transmittance of near-infrared light by the filter as a diagonal component are arranged; and

restoring a separation signal related to a visible light signal and a near infrared signal by using the visible light component and the near infrared component.

(Supplementary Note 10)

A program for causing a computer to execute processing of:

separating an input signal related to an image signal including near-infrared light that has passed through a filter having a part that transmits near-infrared light and a part that does not transmit near-infrared light into a visible light component and a near infrared component based on an observation matrix in which a diagonal matrix having a visible light transmission pattern indicating a transmittance of visible light by the filter as a diagonal component and a diagonal matrix having a near-infrared light transmission pattern indicating a transmittance of near-infrared light by the filter as a diagonal component are arranged; and

restoring a separation signal related to a visible light signal and a near infrared signal by using the visible light component and the near infrared component.

(Supplementary Note 11)

An image processing device including:

a signal acquisition means that acquires an input signal related to an image including near-infrared light that has passed through a filter that includes a part that transmits near-infrared light and a part that does not transmit near-infrared light and that transmits visible light as an observation vector;

a separation means that separates the input signal into a visible light component and a near infrared component based on an observation matrix indicating an effect given to the input signal by the filter and convert the separated components into a frequency region by using a basic matrix and a coefficient; and

a restoration means that restores the visible light component and the near-infrared light component to a separation signal related to a visible light signal and a near infrared signal based on the basic matrix and the coefficient.

(Supplementary Note 12)

An image processing method including:

acquiring an input signal related to an image including near-infrared light that has passed through a filter that includes a part that transmits near-infrared light and a part that does not transmit near-infrared light and that transmits visible light as an observation vector;

separating the input signal into a visible light component and a near infrared component based on an observation matrix indicating a relationship between the input signal and a near infrared signal or a visible light signal;

converting the visible light component and the near infrared component into an expression using a basic matrix and a coefficient; and

restoring the visible light component and the near infrared component to a separation signal related to a visible light signal and a near infrared signal based on the basic matrix and the coefficient.

(Supplementary Note 13)

A program for causing a computer to execute processing of:

acquiring an input signal related to an image including near-infrared light that has passed through a filter that includes a part that transmits near-infrared light and a part that does not transmit near-infrared light and that transmits visible light;

separating the input signal into a visible light component and a near infrared component based on an observation matrix indicating a relationship between the input signal and a near infrared signal or a visible light signal;

converting the visible light component and the near infrared component into an expression using a basic matrix and a coefficient; and

restoring the visible light component and the near infrared component to a separation signal related to a visible light signal and a near infrared signal based on the basic matrix and the coefficient.

(Supplementary Note 14)

An imaging device including:

a coded IR cut filter that includes a part that transmits near-infrared light and a part that does not transmit near-infrared light and transmits visible light;

a color filter that divides entered light into a plurality of colors;

a photosensor that converts the plurality of colors obtained by dividing the light by the color filter into an image signal;

an acquisition means that acquires an input signal related to an image signal including near-infrared light that has passed through the coded IR cut filter;

a separation means that separates the input signal into a visible light component and a near infrared component based on an observation matrix indicating an effect given to the input signal by the coded IR cut filter and converts the visible light component and the near infrared component into an expression using a basic matrix and a coefficient; and

a restoration means that restores the visible light component and the near infrared component to a separation signal related to a visible light signal and a near infrared signal based on the basic matrix and the coefficient.

(Supplementary Note 15)

An image processing device including:

a separation means that expresses an input signal by a linear relationship of y=Mx when y indicate the input signal related to an image signal including near-infrared light that has passed through a coded IR cut filter that has a part that transmits near-infrared light and a part that does not transmit near-infrared light as an observation vector, M indicate an observation matrix in which a diagonal matrix having a ratio of visible light that has passed through the coded IR cut filter and is detected as an element and a diagonal matrix having a ratio of near-infrared light as an element are arranged, and x indicate a signal obtained by separating the input signal y into a visible light component and a near infrared component, and converts the signal x into a frequency region by using a basic matrix Φ and a coefficient s; and

a restoration means that restores the signal x based on the basic matrix and the coefficient s.

(Supplementary Note 16)

An image processing method including:

expressing an input signal by a linear relationship of y=Mx when y indicate the input signal related to an image signal including near-infrared light that has passed through a coded IR cut filter that has a part that transmits near-infrared light and a part that does not transmit near-infrared light as an observation vector, M indicate an observation matrix in which a diagonal matrix having a ratio of visible light that has passed through the coded IR cut filter and is detected as an element and a diagonal matrix having a ratio of near-infrared light as an element are arranged, and x indicate a signal obtained by separating the input signal y into a visible light component and a near infrared component, and converting the signal x into a frequency region by using a basic matrix Φ and a coefficient s; and

restoring the signal x based on the basic matrix Φ and the coefficient s.

(Supplementary Note 17)

A program for causing a computer to execute processing of:

expressing an input signal by a linear relationship of y=Mx when y indicate the input signal related to an image signal including near-infrared light that has passed through a coded IR cut filter that has a part that transmits near-infrared light and a part that does not transmit near-infrared light as an observation vector, M indicate an observation matrix in which a diagonal matrix having a ratio of visible light that has passed through the coded IR cut filter and is detected as an element and a diagonal matrix having a ratio of near-infrared light as an element are arranged, and x indicate a signal obtained by separating the input signal y into a visible light component and a near infrared component, and converting the signal x into a frequency region by using a basic matrix Φ and a coefficient s; and

restoring the signal x based on the basic matrix Φ and the coefficient s.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An image processing device comprising:
at least one memory storing a set of instructions; and
at least one processor configured to execute the instructions to:
separate an input signal related to an image signal including near-infrared light that has passed through a filter having a part that transmits near-infrared light and a part that does not transmit near-infrared light, into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component; and
restore a separation signal related to a visible light signal and a near infrared signal based on the visible light component and the near infrared component.

2. The image processing device according to claim 1, wherein the processor is further configured to execute the instructions to:
acquire the image signal; and
convert the image signal into the input signal that is an observation vector.

3. The image processing device according to claim 1, wherein the processor is further configured to execute the instructions to:
acquire a transmission pattern including the visible light transmission pattern or the near-infrared light transmission pattern; and
generate the observation matrix based on the acquired transmission pattern.

4. The image processing device according to claim 1, wherein
the visible light component and the near infrared component is converted into a frequency region by using a basic matrix and a coefficient, and
the separation signal is restored based on the basic matrix and the coefficient.

5. The image processing device according to claim 4, wherein the processor is further configured to execute the instructions to:
generate an updated basic matrix using the coefficient as an improved sparse signal and update the basic matrix, wherein
the visible light component and the near infrared component is converted into the frequency region based on the updated basic matrix.

6. The image processing device according to claim 1, wherein the processor is further configured to execute the instructions to:
convert the restored separation signal into a visible light image and a near-infrared light image.

7. The image processing device according to claim 6, wherein the processor is further configured to execute the instructions to:
output the converted visible light image and near-infrared light image.

8. The image processing device according to claim 1, wherein
a length of a vector of the input signal is n (n is natural number equal to or more than 100), the observation matrix includes n rows and 2n columns, and a length of a vector of the separation signal is 2n.

9. An image processing method comprising:
separating an input signal related to an image signal including near-infrared light that has passed through a filter having a part that transmits near-infrared light and a part that does not transmit near-infrared light into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component; and
restoring a separation signal related to a visible light signal and a near infrared signal based on the visible light component and the near infrared component.

10. A non-transitory computer-readable medium storing a program for causing a computer to execute processing, the processing comprising:
separating an input signal related to an image signal including near-infrared light that has passed through a filter having a part that transmits near-infrared light and a part that does not transmit near-infrared light into a visible light component and a near infrared component based on an observation matrix, the observation matrix aligning a diagonal matrix having a visible light transmission pattern indicating visible light transmittance by the filter as a diagonal component and a diagonal matrix having a near-infrared light transmission pattern indicating near-infrared light transmittance by the filter as a diagonal component; and
restoring a separation signal related to a visible light signal and a near infrared signal based on the visible light component and the near infrared component.
